(19) United States
(12) Patent Application Publication
(10) Pub. No.: US 2015/0321753 A1
(43) Pub. Date: Nov. 12, 2015

(54) CIRCULAR FORCE GENERATOR DEVICES, SYSTEMS, AND METHODS FOR USE IN AN ACTIVE VIBRATION CONTROL SYSTEM

(71) Applicants: Paul R. BLACK, (US); Doug A. SWANSON, (US); Askari BADRE-ALAM, (US); Michael D. JANOWSKI, (US); Russell E. ALTIERI, (US); Andrew D. MEYERS, (US); Jihan RYU, (US); LORD CORPORATION, Cary, NC (US)

(72) Inventors: Paul R. BLACK, Fuquay-Varina, NC (US); Doug A. SWANSON, Cary, NC (US); Askari BADRE-ALAM, Cary, NC (US); Michael D. JANOWSKI, Clayton, NC (US); Russell E. ALTIERI, Holly Springs, NC (US); Andrew D. MEYERS, Apex, NC (US); Jihan RYU, Cary, NC (US)

(21) Appl. No.: 14/647,700

(22) PCT Filed: Nov. 22, 2013
(86) PCT No.: PCT/US2013/071452

§ 371 Date: May 27, 2015

Related U.S. Application Data
(60) Provisional application No. 61/736,148, filed on Dec. 12, 2012.

(51) Int. Cl. B64C 27/00; F16F 7/10

(52) U.S. Cl. CPC B64C 27/001; F16F 7/1011; B64C 2027/004

(57) ABSTRACT

Improved circular force generator devices (100), systems, and methods for use in an active vibration control system are disclosed. The present subject matter can include improved rotary actuator devices, systems, and methods in which a center shaft (120) is positioned in a fixed relationship with respect to a component housing (114). At least one movable body can be positioned in the component housing and rotatably coupled to the center shaft by a radial bearing (130), the at least one movable body comprising a motor (110) and at least one eccentric mass (150). With this configuration, the motor can be configured to cause rotation of the movable body about the center shaft to produce a rotating force with a controllable rotating force magnitude and a controllable rotating force phase.

### PRIORITY CLAIM

The present application claims the benefit of U.S. Provisional Patent Application Ser. No. 61/173,148, filed Dec. 12, 2012, the disclosure of which is incorporated herein by reference in its entirety.

### TECHNICAL FIELD

The subject matter disclosed herein relates to devices, systems, and methods for controlling problematic vehicle vibrations. More particularly, the subject matter disclosed herein relates to methods and systems for controlling helicopter and/or fixed wing vehicle vibrations and/or noise, particularly methods and systems for canceling problematic rotating helicopter vibrations.

### BACKGROUND

Helicopter vibrations are particularly troublesome in that they can cause fatigue and wear on the equipment and occupants in the aircraft. In vehicles such as helicopters, vibrations are particularly problematic in that they can damage the actual structure and components that make up the vehicle in addition to the contents of the vehicle.

There is a need for a system and method of accurately and economically canceling rotating vehicle vibrations, accurately controlling rotary wing vibrations in a weight efficient manner, controlling vibrations in a helicopter hub so that the vibrations are efficiently minimized, and/or controlling problematic helicopter vibrations.

### SUMMARY

In accordance with this disclosure, improved rotary actuator devices, systems, and methods are provided in which a center shaft is positioned in a fixed relationship with respect to a component housing. At least one movable body can be positioned in the component housing and rotatably coupled to the center shaft by a bearing, the at least one movable body comprising a motor rotor and at least one eccentric mass. With this configuration, the motor can be configured to cause rotation of the movable body about the center shaft to produce a rotating force with a rotating force magnitude and a controllable rotating force phase.

In another aspect, a method of active vibration control can comprise rotating at least one movable body about a center shaft positioned in a fixed relationship with respect to a component housing, the at least one movable body being rotatably coupled to the center shaft by a bearing, and the at least one movable body comprising at least one eccentric mass, wherein rotating the at least one movable body produces a rotating force. The method can further comprise controlling at least one of a rotating force magnitude and a rotating force phase of the rotating force.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1A is a graph illustrating a relationship between the bore diameter of a bearing of a circular force generator and the power required for operation of the circular force generator.

FIG. 1B is a graph illustrating a relationship between the frequency of operation of a circular force generator and the power required for operation.

FIG. 2 is a sectional side view illustrating a circular force generator according to an embodiment of the presently disclosed subject matter.

FIG. 3 is an exploded perspective view illustrating a circular force generator according to an embodiment of the presently disclosed subject matter.

FIG. 4 is a partially-exploded perspective view illustrating a motor of a circular force generator according to an embodiment of the presently disclosed subject matter.

FIG. 5A is a graph illustrating the position control error of a conventional circular force generator that uses an encoder.

FIG. 5B is a graph illustrating the position control error of a circular force generator using a Hall-effect servo control system according to an embodiment of the presently disclosed subject matter.

FIGS. 6A-6D are perspective views illustrating various form factors for circular force generators according to embodiments of the presently disclosed subject matter.

FIG. 7 is a sectional side view illustrating a circular force generator having integrated control electronics according to an embodiment of the presently disclosed subject matter.

FIG. 8 is a schematic view illustrating an active vibration control system according to an embodiment of the presently disclosed subject matter.

FIG. 9 is a schematic model illustrating two masses rotating about a common axis.

FIG. 10 is a graph illustrating the bi-axial force output of 2 circular force generators (e.g., 4 rotating masses).

FIGS. 11A and 11B are force diagrams for circular force generators having two rotating masses according to embodiments of the presently disclosed subject matter.

FIG. 12 is a graph illustrating a relationship between force output and moment output for a circular force generator having plural rotating masses according to an embodiment of the presently disclosed subject matter.

FIG. 13A is a graph illustrating a relationship between maximum N/rev force and maximum 2nd harmonic force for a circular force generator according to an embodiment of the presently disclosed subject matter.

FIG. 13B is a graph illustrating a relationship between maximum N/rev force and maximum residual moment for a circular force generator according to an embodiment of the presently disclosed subject matter.

FIGS. 14A to 14C are illustrations of a weight-optimized mass for a circular force generator according to an embodiment of the presently disclosed subject matter.

FIGS. 15A to 15C are illustrations of a moment-optimized mass for a circular force generator according to an embodiment of the presently disclosed subject matter.

FIG. 16 shows a block diagram of a motor control gravity compensation that uses the vertical acceleration at the base of the circular force generator to reduce the force distortion at the second harmonic according to an embodiment of the presently disclosed subject matter.

### DETAILED DESCRIPTION

The present subject matter provides improvement in circular force generators (CFGs) for use in an active vibration control system, such as is used to control vibration in a helicopter. The disclosed devices, systems, and methods can entail modifications to both software and hardware to control the CFG and/or to minimize force distortion created by the CFG. These devices, systems, and methods can be implemented in the CFG and can be particularly useful under low force operating conditions where the residual vibration created by the CFG can be larger than the vibration created by the main rotor of the helicopter, which can be undesirable to the customer. Low force is typically less than 30% of the maximum force output of the CFG and on a helicopter active vibration control system can occur during conditions such as hover or at mid-speed flight ranges (e.g. 80-100 kias).

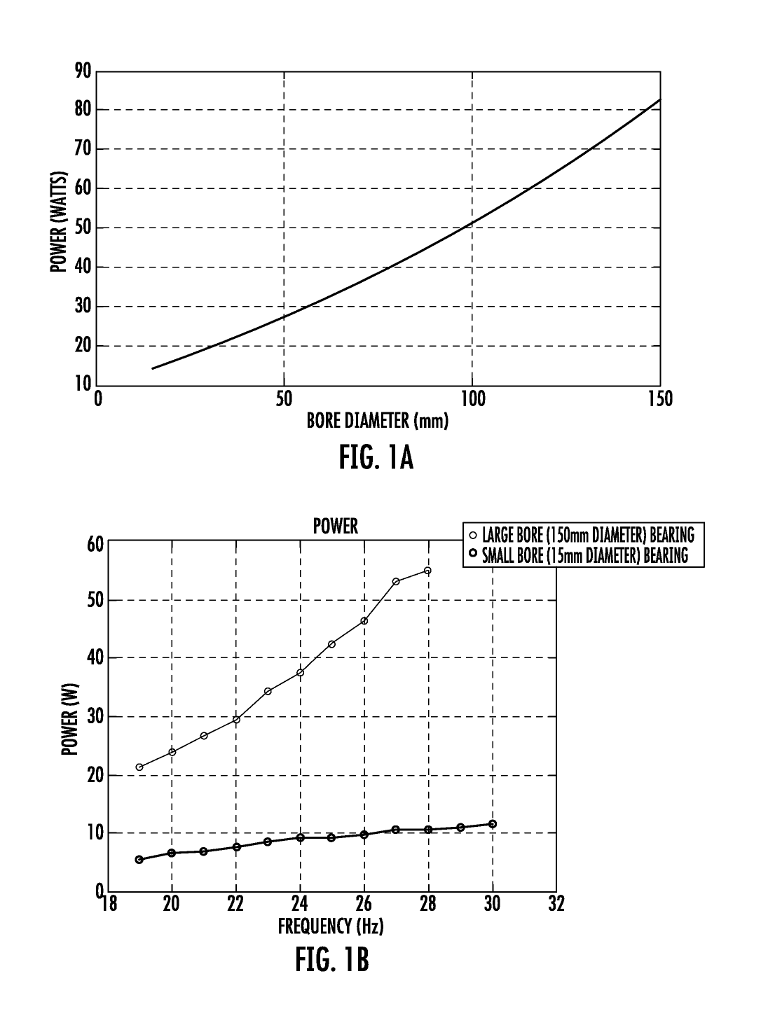

In a first aspect, the disclosed devices, systems, and methods can involve the use of a CFG having a bearing (e.g., a ball bearing or other rolling-element bearing) with a diameter that can be comparatively smaller than that of a conventional CFG. Large diameter bearings were used in the past partially due to the sensing technology (centerline encoder), which did not allow for a center shaft with small diameter bearing. Specifically, for example, whereas conventional CFGs can have a bearing diameter of about 150 mm, a CFG according to the present subject matter can be configured to have a bearing diameter of about 15 mm. The reduced bearing diameter can result in a reduced ball speed during operation at a given rotational speed compared to conventional systems, thereby lowering power requirements. (See, e.g., FIG. 1A) Furthermore, as shown in FIG. 1B, even when the frequency of operation is increased, the power required for such operation can be maintained at a comparatively lower level.

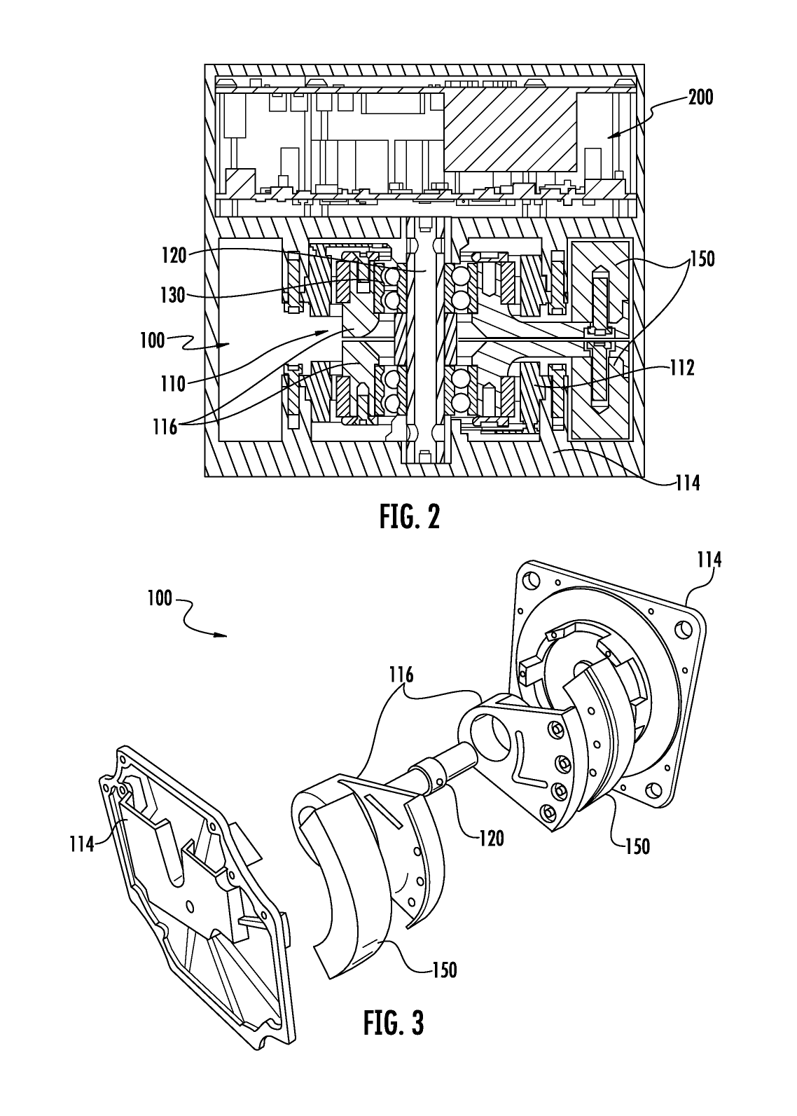

In a particular configuration shown in FIGS. 2 and 3, for example, a CFG, generally designated 100, includes a pair of motors 110 each having a stator 112 mounted to endplates 114. A rotor 116 of each motor 110 is coupled for rotation about a stationary center shaft 120 by a bearing 130 mounted inside the motor 110. A rotating mass 150 is eccentrically connected to each rotor 116 such that rotation of the rotor 116 about the shaft 120 can generate a “circular” force.

Each of these elements of such a configuration allows for a comparatively lower profile design. In particular, the size of the bearing 130 provides a number of advantages over conventional CFG configurations. In some aspects, such novel bearings can be press fit on or about portions of a shaft and/or rotor frames to reduce any differential in thermal expansion. Moreover, the shaft, rotor, bearings, and/or portions thereof can be fabricated out of materials having a same or similar coefficient of thermal expansion (CTE). This can be advantageous for both improving wear and reducing fatigue. Such components can each be fabricated from a similar steel material or alloy, a similar aluminum (Al) material or alloy, or any other similar materials or metals having similar CTEs. Bearings, which can be press fit on steel shaft or rotors, improves wear fatigue and allows for smaller internal clearances. The improved bearings can be disposed on or about a centerline shaft. This results in a lowered drag torque, which results in reduced power requirements and a reduced motor size. For example, the CFG 100 having such a configuration operates at a much lower power level as discussed above. In addition, the bearing 130 generates less heat as a result, allowing the CFG 100 to operate in an extended temperature range (e.g., between about −54 to 70° C.). The press fit of bearing onto shaft also produces less noise than current bearings. The increased ratio of the size of the balls within the bearing 130 with respect to the cross sectional dimension further enables a longer operating life for the CFG 100 compared to traditional designs.

In another aspect, the improved CFG devices, systems, and methods include a high accuracy servo controller 200 that uses a plurality of rotating mass sensors to monitor the rotational position of the rotating mass 150 on the rotor 116 being driven by the motor 110 such that the controller 200 knows the rotational phase position of the rotating mass 150. For example, the rotating mass sensors can comprise Hall-effect sensors configured for sensing the rotation of a magnetic rotating mass sensor target to provide out through a circuit board 202 to the system controller the rotational position of the rotating mass 150. In one particular configuration shown in FIG. 4, and in addition to one or more standard commutation Hall sensors (e.g., embedded within stator 112), an additional 1/rev Hall sensor 160b (e.g., mounted on a printed circuit board on top of stator 112) can be used for servo control of the CFG 100. Specifically, 1/rev Hall sensor 160b can be configured to precisely monitor the position of rotor 116 based on the position of one or more target magnets 160a. The configuration shown in FIG. 4 is but one exemplary arrangement, and the particular number and positioning of the rotating mass sensors can be modified based on a variety of design considerations of the system.

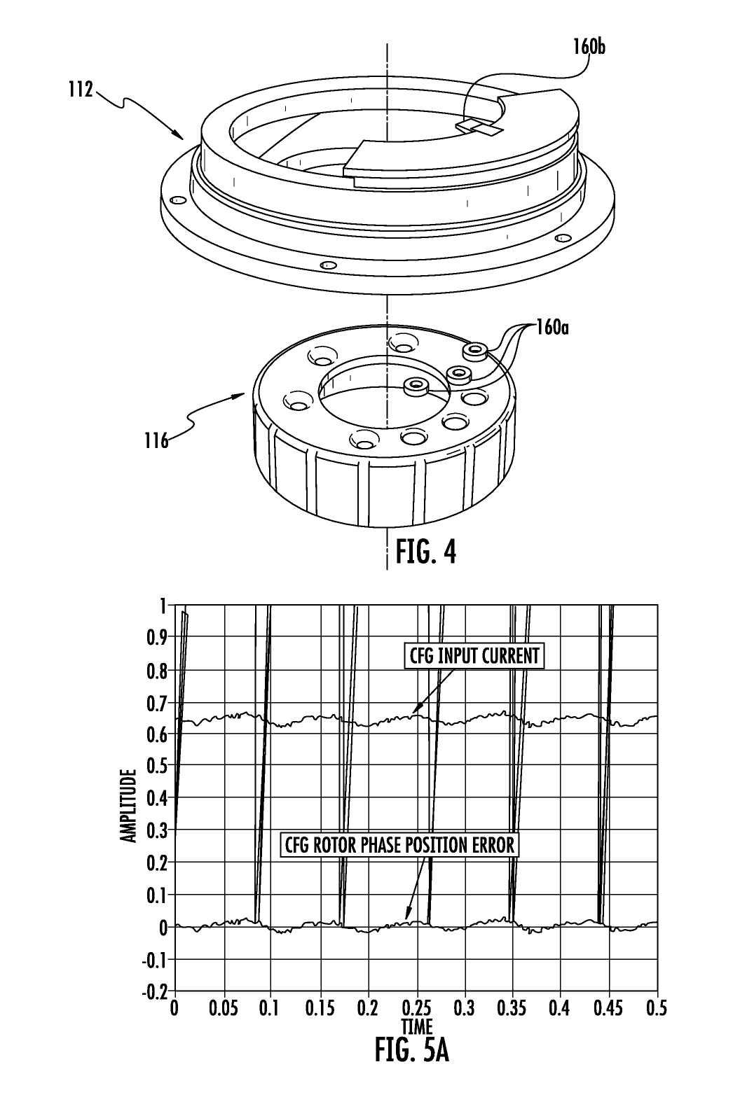

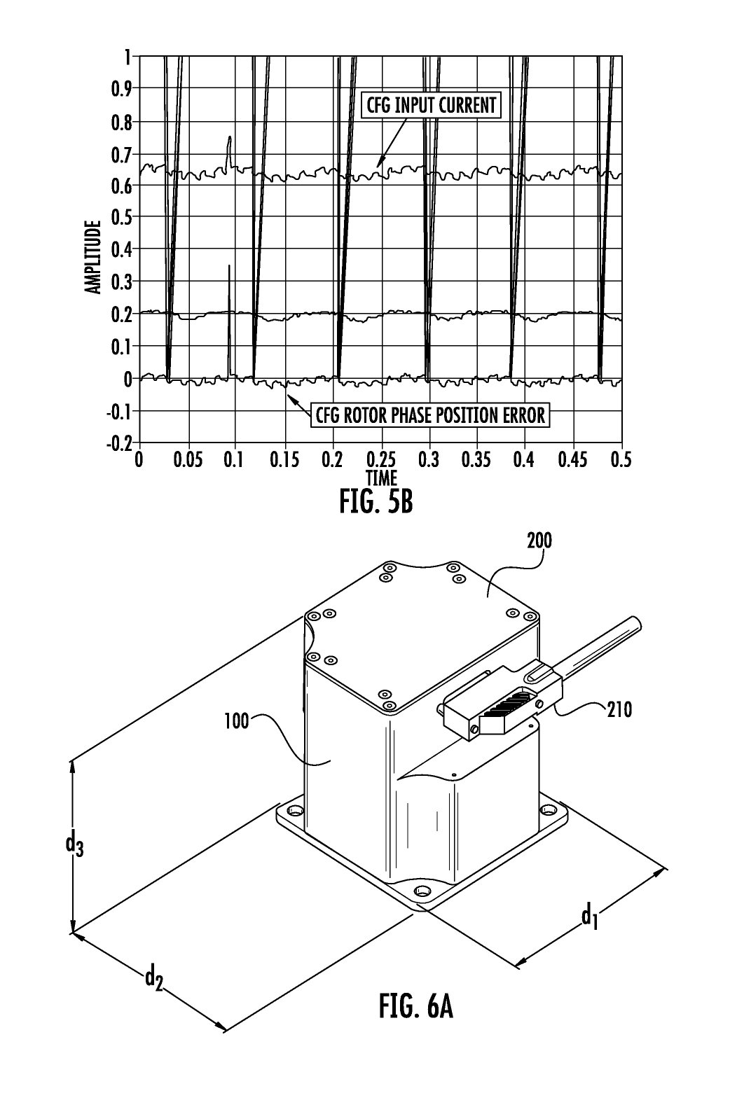

The accuracy of such a control configuration can be comparable to an encoder or resolver servo controller. As shown in FIGS. 5A and 5B, the position control error realized when using an encoder (See FIG. 5A) is only marginally better than the hall-effect sensor position control error (See FIG. 5B). By eliminating the need for an encoder or resolver, however, even if there is a small increase in position control error, that small detriment is offset by the great simplification in the design (e.g., reduce size/cost) and electronics. Furthermore, as discussed above with reference to FIG. 4, such a configuration only requires one additional hall sensor (i.e., 1/rev Hall sensor 160b), which can be built into the existing motor circuitry.

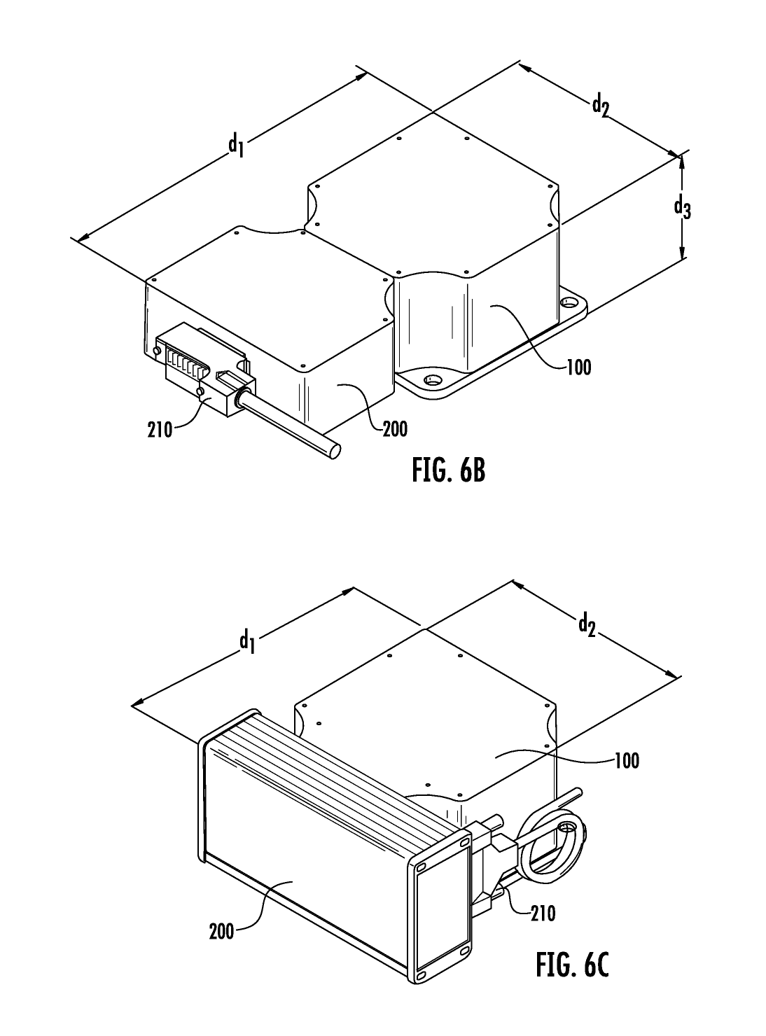

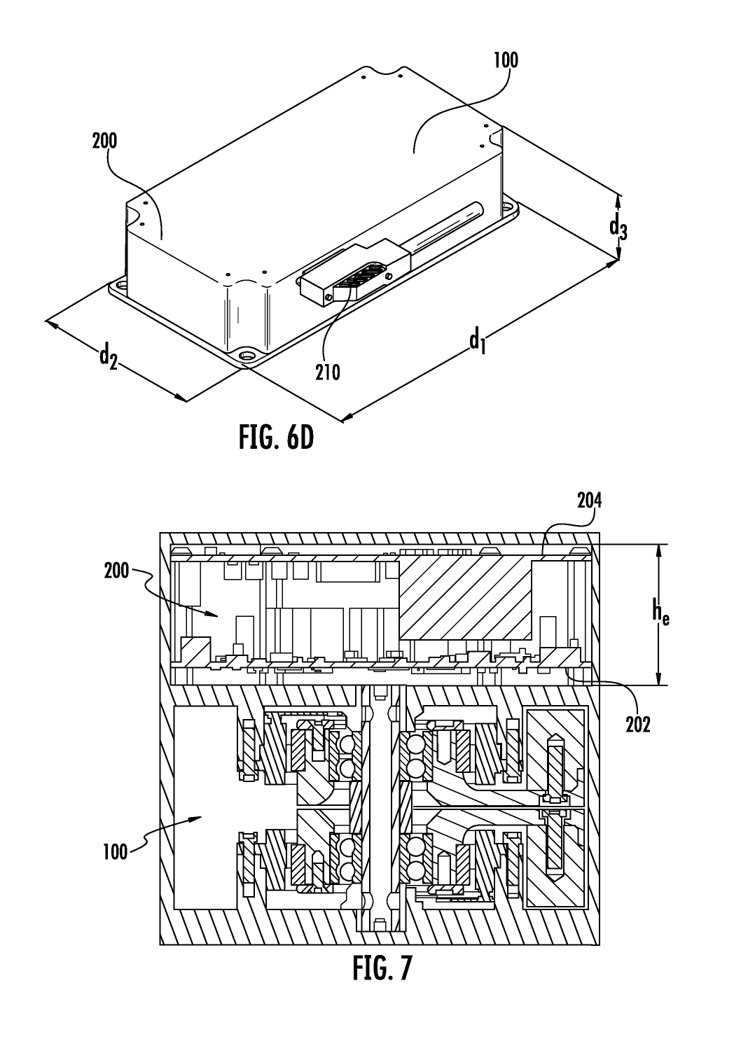

A further feature of the disclosed devices, systems, and methods is that, rather than being oil-lubricated, the bearing 130 can be a substantially sealed greased bearing. This feature simplifies lubrication requirements and allows the CFG 100 to be mounted in any orientation, thereby improving flexibility of the system and its ability to match the complex vibration field in the helicopter in an optimal manner. In this regard, as shown in FIGS. 6A-6D, a modular CFG according to the presently-disclosed subject matter is easily implemented in any of a variety of different form factors. For instance, FIG. 6A shows the CFG 100 and the controller 200 being arranged in a stacked configuration with a connector 210 (e.g., a D-sub connector or a D38999 connector) being connected to the controller 200 for communication with the system controller. In this configuration, both a length d1 (e.g., about 5.4 inches) and a width d2 (e.g., about 5.4 inches) of the CFG 100 are minimized. This small footprint comes at the expense of a relatively increased height d3 (e.g., about 4.7 inches) of the CFG 100, but even in this arrangement, the integrated package is still relatively compact when compared to conventional systems.

Alternatively, FIGS. 6B-6C each show various side-by-side configurations in which the CFG 100 and the controller 200 can be arranged. Each of these exemplary configurations results in a relatively lower-profile design having a reduced height d3 (e.g., between about 2.5 to 3 inches) compared to the stacked configuration shown in FIG. 6A, although this reduction in height is offset by an increased length d1 (e.g., between about 7.1 and 10.5 inches). Those having skill in the art will recognize that the different form factors shown in FIGS. 6A-6D can be considered advantageous depending on the specific constraints of a particular mounting location (e.g., size, orientation, access). Furthermore, those having skill in the art will recognize that these exemplary configurations only illustrate four possible implementations, and other configurations can be used depending on these or other particular design considerations. By way of example, controller 200 may be remotely attached to CFG 100 by a cable or conduit. Additionally, controller 200 and CFG 100 may have a modular configuration where controller 200 may be detachable from CFG 100 via a plug, such as aviation quick-connect plugs. The use and positioning of the plug on the CFG is compatible with all configuration discussed herein.

Taken together, all of the improvements in the presently-disclosed CFG 100 results in a simpler mechanical assembly. For example, whereas previous CFG designs can constitute 18 machined parts, the improved CFG 100 disclosed herein (See, e.g., FIG. 3) uses significantly fewer machined parts (e.g., as few as 7 parts or fewer). As a result, the compact design allows motor mounting features to be incorporated into the CFG 100, thereby eliminating the need for separate motor retainers and/or bearing retainers. Further in this regard, the presently disclosed subject CFG 100 has a significantly lower manufacturing cost than previous designs.

Referring to FIG. 7, the design can be made further compact and modular by integrating the drive electronics into the CFG 100, which can be enabled, at least partially, as a result of the reduced heat generation of the relatively low-power CFG. For example, the controller 200 can be a highly-integrated micro-controller that includes a signal board 202 and a power board 204 that occupy an electronics volume that protrudes only a small distance hₑ (e.g., about 1.765 inches or less) from the CFG 100. Such a configuration allows the controller 200 to operate as a completely stand-alone module, with the module configured to receive high-level digital commands from a small central controller. This modularity of co-located drive electronics enables any number of CFGs to be efficiently implemented.

Regardless of the specific configuration of the CFG 100, one or more of CFG 100 can be operated together as part of an active vibration control system. FIG. 8 illustrates an exemplary configuration for such an active vibration control system having a plurality of CFGs 100 connected to a small central controller 300. In addition, one or more input devices can further be connected to the central controller 300 to help determine the vibration being experienced. For example, a tachometer 310 that measures the rotor speed of the aircraft in which it is used and one or more accelerometers 320 provide inputs to the central controller 300. Based on these inputs, each CFG can be controlled to reduce the effect of the measured vibrations on the system.

The present systems can be configured such that operating power for each CFG 100 can be provided by an unregulated aircraft power source (e.g., about 28 VDC). This low power design enables both the central controller 300 and the CFG drive electronics (i.e., controller 200) to run off of an unregulated 28 VDC aircraft supply, which provides a wide range of advantages, such as simplifying design, saving cost, and saving the weight and space that would be required for a separate generator on a smaller aircraft. This low-power capability is helpful in active vibration control systems for smaller aircraft which only have 28 VDC aircraft power available and not the high-voltage systems (e.g., 115 VAC or 270 VAC) that are conventionally required to power the operation of force actuators.

As a result of the more compact size and modular nature of the improved CFG devices, systems, and methods disclosed herein, multiples of the CFG 100 can be arranged in pairs/arrays and specifically controlled to minimize or otherwise control force distortion created by the CFGs. For example, each CFG can be selectively operated to produce a circular force of varying magnitude and phase. The force of each rotor 116 can be determined by a size (m) of the rotating mass 150, a distance (r) to a center of the rotating mass 150, and its angular speed (ω):

F₀=mrω²,

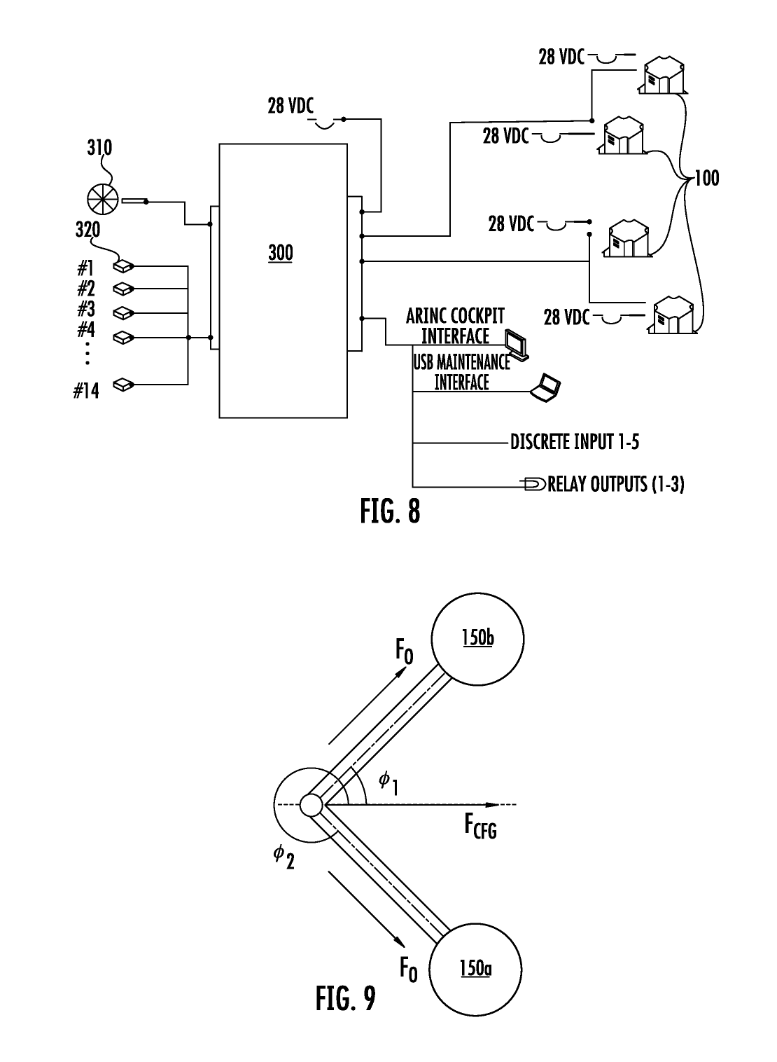

With the configuration shown in FIG. 9, the total CFG force of two masses (e.g., a first rotating mass 150a and a second rotating mass 150b) rotating about a common axis are determined by the force of each rotor and their relative phase angles:

$${F}_{CFG} = 2 {F}_{0} cos ( \frac{{ϕ}_{1} - {ϕ}_{2}}{2} )$$

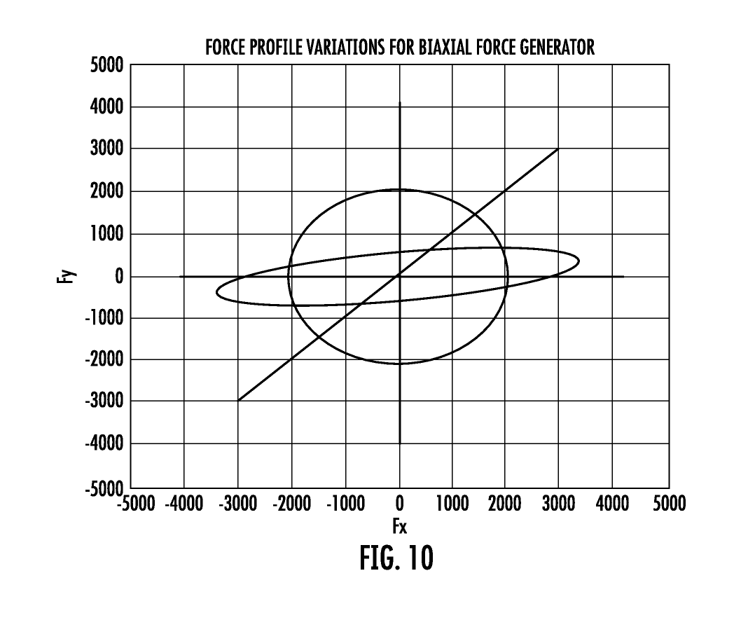

Based on such known relationships, the two imbalanced masses 150a and 150b can be configured to co-rotate such that the combination of the two generates circular forces acting radially outward. In this way, whereas one CFG produces a circular force, two counter-rotating CFGs mounted side-by-side or back-to-back are configured to produce a bi-linear force. (See, e.g., FIG. 10). The controlled combination of circular forces from multiple CFGs is used to achieve higher degrees of vibration control.

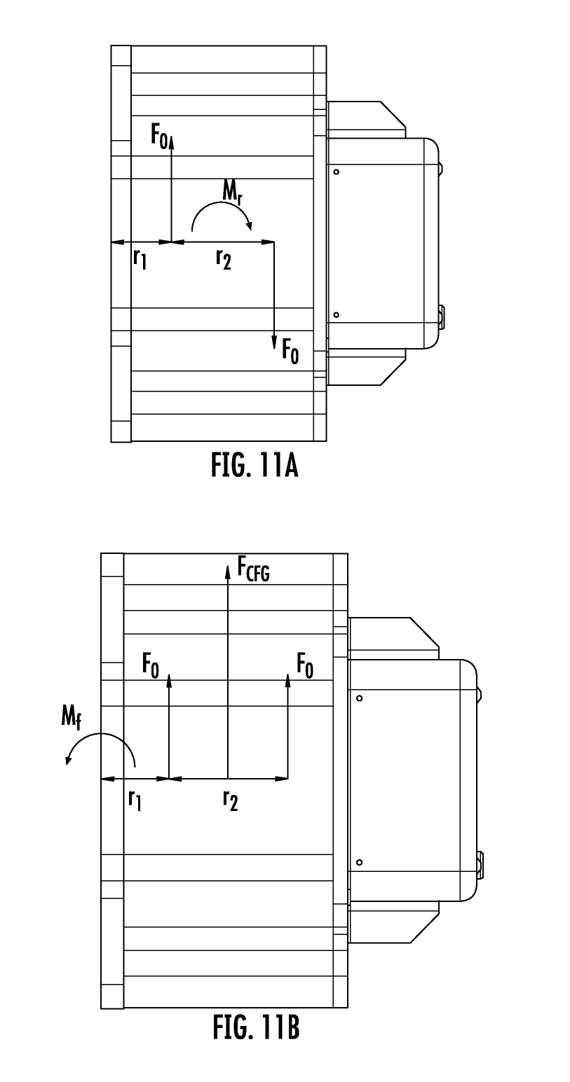

Referring to FIG. 11A, when CFGs are arranged in pairs, the imbalanced masses revolve in distinct parallel planes that are separated by a distance (e.g., r₂-r₁), whereby the opposing force components produce a residual moment (Mᵣ). This residual moment varies inversely with the force output:

$${M}_{r} = {r}_{2} \cdot {F}_{0} sin ( \frac{{ϕ}_{1} - {ϕ}_{2}}{2} )$$

As illustrated in FIG. 11B, because the imbalanced masses each typically revolve in planes some distance from a mounting bracket, the total force of the CFGs produces moment about the mounting bracket. This force moment varies linearly with the force output:

$${M}_{f} = ( {r}_{1} + \frac{1}{2} {r}_{2} ) \cdot {F}_{CFG}$$

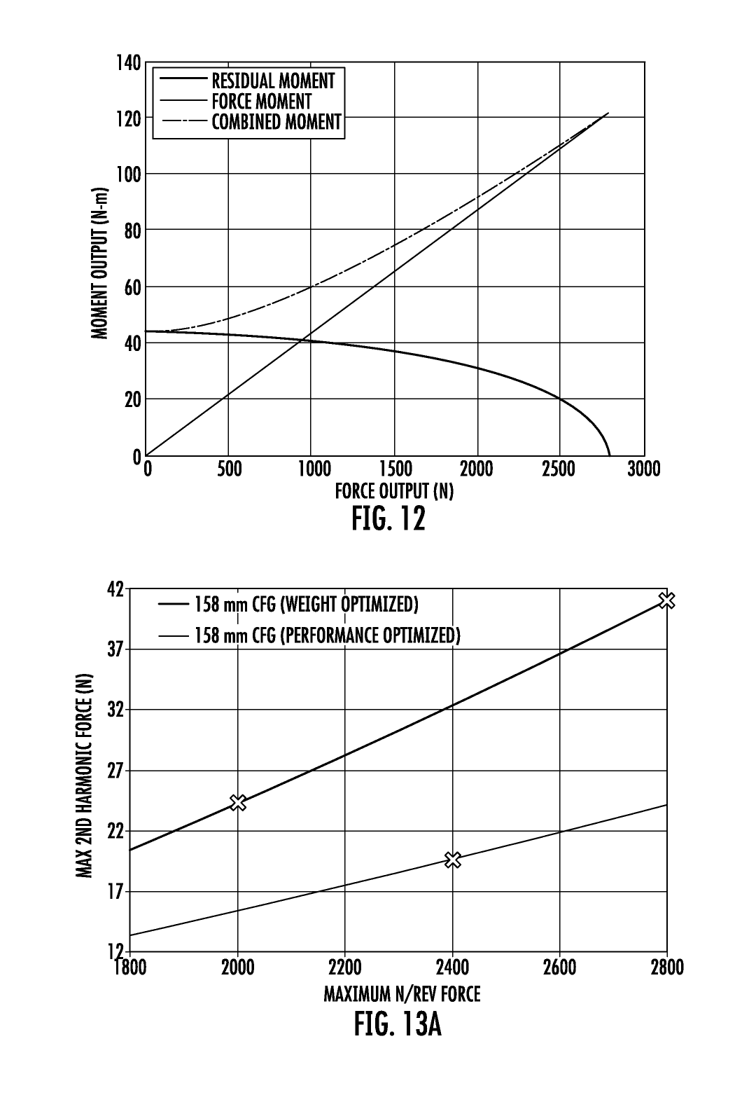

The residual moment and force moment are perpendicular, and the total moment of the CFGs is the vector sum of residual and force moment as shown in FIG. 12:

M_{CFG}=\sqrt{Mᵣ²+M_{f}²}

Residual moments can further be minimized by reducing the distance (e.g., r₂) between the center of mass of the two imbalanced masses. Another approach to reduce the residual moment is to change the inertia (J) of the rotating (movable) imbalance. By increasing the inertia (J), the residual moment is decreased.

In another exemplary implementation, when a CFG is mounted vertically, gravity accelerates and decelerates the imbalanced masses as they revolve:

$$ω = ( \frac{mrg}{J {ω}_{0}} ) sin ( {ω}_{0} t + ϕ ) + {ω}_{0}$$

This fluctuation in speed due to gravity creates a force distortion at the second harmonic, which is inversely proportional to angular speed (ω) and rotor inertia (J), proportional to the imbalance authority (mr), and varies with the relative phase angle (φ). The 2nd harmonic distortion can be much more pronounced at low force outputs such that total harmonic distortion (THD) is predominantly due to the 2nd harmonic.

Referring to FIG. 13A, the second harmonic force distortion can also be reduced by increasing the inertia of the imbalanced mass, which results in a decrease in the residual moment as well (See, e.g., FIG. 13B).

In another embodiment, measurement of the acceleration at the base of the CFG is used in the motor control feedback to reduce the second harmonic distortion. For example, one of the one or more accelerometers 320 can be incorporated onto co-located electronics (e.g., integrated with the controller 200). As discussed above, this CFG-positioned accelerometer can also be used to control vibration by providing an input to the central controller 300 for determining the vibration to be controlled. FIG. 16 shows a block diagram of the accelerometer in the motor control. The gravity compensation term for motor control is calculated from the following general equation:

V_{GC}=f(φ,F_{cmd},a_{z})

where
V_{GC}=Gravity compensation for motor control
φ=Rotor position
F_{cmd}=Force command
a_{z}=Vertical acceleration

V_{GC} can be implemented as analytical function or table look-up. One exemplary form of the above function for voltage motor control is as follows.

V_{GC}=A_{GC} sin(φ+P_{GC})·C_{F}(F_{cmd})·Cₐ(a_{z})

A_{GC} and P_{GC} are amplitude gain and phase, respectively, to take dynamics of motor circuit into account. C_{F}(F_{cmd}) and Cₐ(a_{z}) are variable coefficients to change the gravity compensation amount with respect to force command and vertical acceleration. C_{F}(F_{cmd}) and Cₐ(a_{z}) can be implemented as analytical function or table look-up. Exemplary implementation of C_{F}(F_{cmd}) and Cₐ(a_{z}) are presented in the below.

C_{F}(F_{cmd})−A_{F}F_{cmd}+B_{F}

Cₐ(a_{z})=Aₐa_{z}

where A_{F}, B_{F}, and Aₐ are tuning parameters. Note that the accelerometer can have additional functionality.

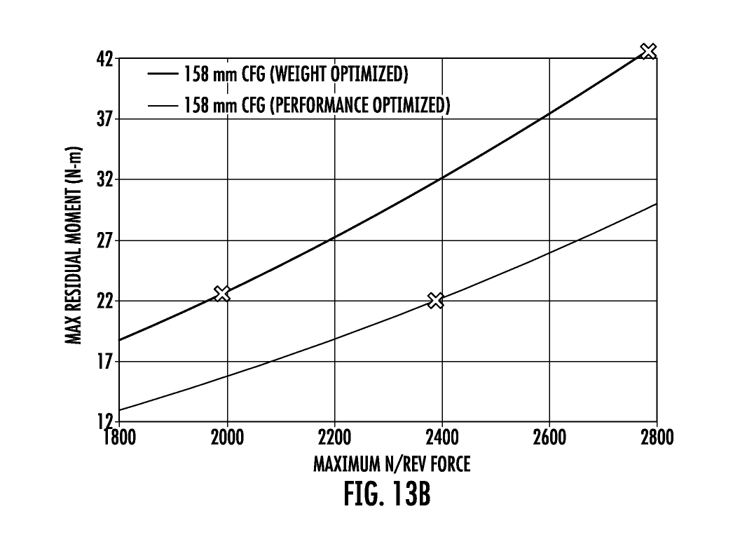

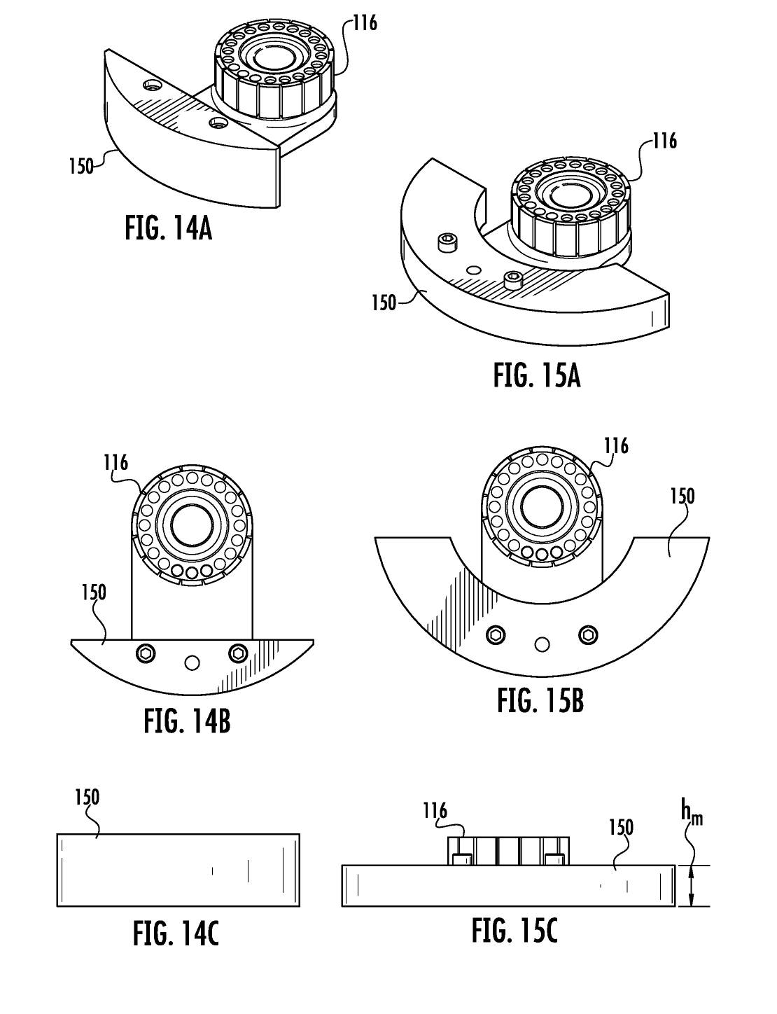

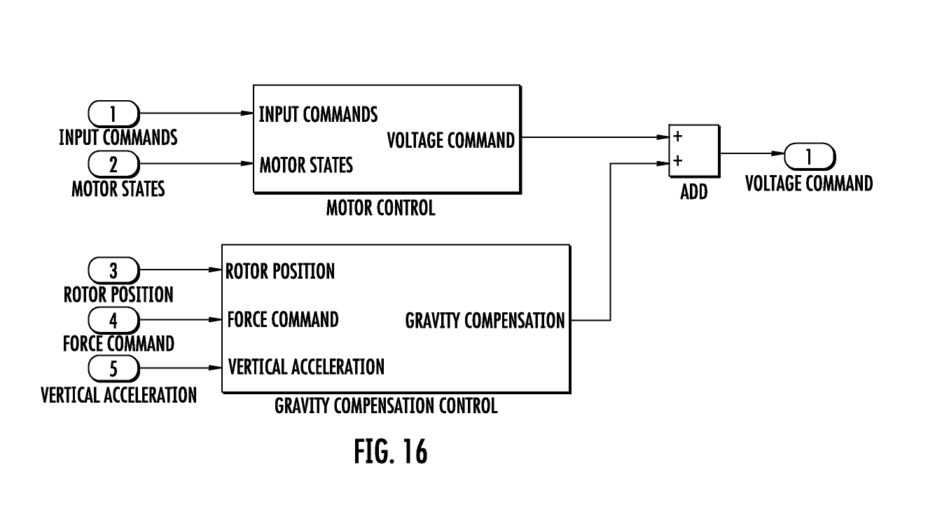

FIGS. 14A-14C and 15A-15C show various configurations for the rotating mass 150. Specifically, FIGS. 14A-14C depict the rotating mass 150 in a “weight optimized” configuration in which a center of mass of the rotating mass 150 is spaced at a greatest radius possible relative to the axis of rotation for a given set of system constraints. In this configuration, a substantially equivalent inertia is produced using a rotating mass 150 having a relatively small size. In contrast, FIGS. 15A-15C depict the rotating mass 150 in a “moment optimized” or “performance optimized” configuration in which a height h of the rotating mass 150 is reduced (e.g., about 50% of the thickness of the weight optimized mass) such that adjacent CFGs are positioned closer to one another, thereby allowing the distance (e.g., r₂) between the center of mass of adjacent imbalanced masses to be minimized as discussed above to help reduce the residual moment. The “moment optimized” mass can have an inertia that is approximately twice that of the “weight optimized” mass even though the CFG with a “moment optimized” mass may only be about 10% heavier than the CFG with a “weight optimized” mass.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. A circular force generator for use in an active vibration control system, comprising:
a center shaft positioned in a fixed relationship with respect to a component housing; and
at least one movable body positioned in the component housing and rotatably coupled to the center shaft by a bearing, the at least one movable body comprising a motor and at least one eccentric mass, wherein the motor is configured to cause rotation of the movable body about the center shaft to produce a rotating force with a rotating force magnitude and a controllable rotating force phase.

2. The circular force generator of claim 1, wherein the bearing comprises a ball bearing.

3. The circular force generator of claim 2, wherein the ball bearing has a bore diameter of about 15 mm.

4. The circular force generator of claim 1, wherein the bearing comprises a substantially sealed, grease-lubricated bearing.

5. The circular force generator of claim 1, wherein an inertia of the at least one eccentric mass and a thickness of the at least one eccentric mass are selected to minimize at least one of a residual moment or a second harmonic force distortion of the at least one movable body.

6. The circular force generator of claim 1, comprising a control system configured to control the rotating force magnitude and a rotating force phase of the at least one movable body, the control system comprising a Hall-effect sensor servo control.

7. The circular force generator of claim 6, wherein the Hall-effect sensor servo control comprises a plurality of standard commutation hall sensors and at least one 1/rev hall sensor.

8. The circular force generator of claim 1, comprising a micro-controller contained in the component housing, the micro-controller being configured to receive high-level digital commands from a central controller.

9. The circular force generator of claim 8, wherein the micro-controller is configured to be selectively positioned within the component housing at any of a variety of positions with respect to the at least one movable body.

10. The circular force generator of claim 8, wherein the micro-controller and the central controller are configured to be powered by a 28 VDC aircraft power supply.

11. The circular force generator of claim 8, wherein the central controller generates the high-level digital commands based on inputs from one or more accelerometers.

12. An active vibration control system comprising a plurality of the circular force generator device recited in claim 1, wherein the plurality of circular force generators are collectively controllable to minimize force distortion caused by the plurality of circular force generators.

13. The active vibration control system of claim 12, wherein a distance between centers of mass of each of the plurality of circular force generators is selected to be a minimum distance.

14. A method of active vibration control, the method comprising:
rotating at least one movable body about a center shaft positioned in a fixed relationship with respect to a component housing, the at least one movable body being rotatably coupled to the center shaft by a radial bearing, the at least one movable body comprising at least one eccentric mass, wherein rotating the at least one movable body produces a rotating force; and
controlling at least one of a rotating force magnitude and a rotating force phase of the rotating force.

15. The method of claim 14, wherein rotating the at least one movable body comprises rotating a plurality of movable bodies together to minimize force distortion caused by the plurality of movable bodies.

16. The method of claim 14, wherein controlling the plurality of movable bodies together comprises reducing a second harmonic force distortion.

17. The method of claim 16, wherein controlling the plurality of movable bodies together comprises reducing the second harmonic force distortion only at a force output less than 30% of a maximum force.

18. The method of claim 14, wherein controlling at least one of a rotating force magnitude and a rotating force phase comprises adjusting at least one of a rotating force magnitude and a rotating force phase in response to an input from one or more accelerometers.

19. The method of claim 18, wherein the input from one or more accelerometers comprises a measurement of a base acceleration at or near the at least one movable body; and
wherein adjusting at least one of a rotating force magnitude and a rotating force phase comprises reducing a second harmonic force distortion of the at least one movable body based on the base acceleration.

20. The method of claim 14, wherein controlling at least one of a rotating force magnitude and a rotating force phase comprises:
receiving high-level digital commands from a central controller; and
adjusting at least one of a rotating force magnitude and a rotating force phase in response to the high-level digital commands.
